(19) United States
(12) Patent Application Publication
(10) Pub. No.: US 2024/0283006 A1
(43) Pub. Date: Aug. 22, 2024

(54) COMPOSITE SOLID ELECTROLYTE USING ZEOLITE AND FLUORINE-BASED LITHIUM SALT

(71) Applicant: DAEGU GYEONGBUK INSTITUTE OF SCIENCE AND TECHNOLOGY, Daegu (KR)

(72) Inventors: Jae Hyeon KIM, Daegu (KR); Jamal HASAN, Daegu (KR); Suyeon HYUN, Daegu (KR)

(73) Assignee: DAEGU GYEONGBUK INSTITUTE OF SCIENCE AND TECHNOLOGY, Daegu (KR)

(21) Appl. No.: 18/693,385

(22) PCT Filed: Oct. 19, 2022
(86) PCT No.: PCT/KR2022/095140

§ 371 Date: Mar. 19, 2024

(30) Foreign Application Priority Data
Oct. 19, 2021 (KR) 10-2021-0139559

(51) Int. Cl. H01M 10/056; H01M 10/052

(52) U.S. Cl. CPC H01M 10/056; H01M 10/052; H01M 2300/0071; H01M 2300/0082; H01M 2300/0091

(57) ABSTRACT

The present invention relates to a composite solid electrolyte comprising zeolite and a fluorine-based lithium salt, and a lithium secondary battery using same. In the composite solid electrolyte according to the present invention, the formation of lithium dendrites is dramatically reduced by optimizing the concentration of fluorine-based lithium salt in a composite solid electrolyte containing zeolite, thus making it possible to achieve a composite solid electrolyte and a lithium secondary battery comprising same in which very good electrochemical characteristics are exhibited even after long-term charging and discharging.

### TECHNICAL FIELD

The present invention relates to a composite solid electrolyte including zeolite and a fluorine-based lithium salt and a lithium secondary battery using the same.

### BACKGROUND ART

As a demand for energy capacity of a lithium secondary battery increases, a study to use a lithium metal as a negative electrode is in progress. In this case, when an electrolyte is a liquid electrolyte, there are long-term reliability issues and a risk of ignition. In addition, since the liquid electrolyte contains a large amount of a flammable organic solvent, there is a risk of leakage during secondary battery operation, and thus, a conventional organic liquid electrolyte is not appropriate for a lithium metal battery.

Thus, an all-solid-state battery is emerging as an alternative for stability, energy density, and long lifespan, and a solid electrolyte used in the all-solid-state battery has received considerable attention over the past few years. Herein, a solid electrolyte may be classified into an inorganic lithium ion conductor or a solid polymer electrolyte. However, since it is difficult for the inorganic lithium ion conductor to be in appropriate interfacial contact with an electrode due to its brittle and hard properties, a solid polymer electrolyte which easily maintains a flexible interfacial contact with an adjacent electrode is preferred.

Characteristics of the solid polymer electrolyte are a polymer skeleton and a lithium salt. However, the solid polymer electrolyte has a low ion conductivity (˜10⁻⁶ S/cm; σ) at room temperature, which is a much lower value than a σ value of a conventional liquid electrolyte. Thus, a composite solid electrolyte has been receiving attention recently, and in order to improve the σ value of a solid electrolyte, a study to use nanoparticles, surface-modified nanoparticles, a carbon nanomaterial, a ceramic filler, and the like in the composite solid electrolyte is in progress.

In a lithium secondary battery, a solid electrolyte potentially has better electrochemical stability and stability than a flammable liquid electrolyte. However, a lithium secondary battery including a solid electrolyte has a problem in terms of stability such as short circuit due to lithium dendrite growth during charging. In addition, a solid electrolyte of a lithium secondary battery used in fields such as electric vehicles is required to have high ion conductivity.

Considering this situation, a method for efficiently manufacturing a lithium secondary battery including a composite solid electrolyte having no dendrite for using the technology is still in demand.

### DISCLOSURE

### Technical Problem

An object of the present invention is to provide a composite solid electrolyte which does not form a lithium dendrite in an interface between a lithium metal and an electrolyte.

Another object of the present invention is to provide a lithium secondary battery including a composite solid electrolyte which does not form a lithium dendrite.

### Technical Solution

In one general aspect, a composite solid electrolyte includes: zeolite, an ion conductive polymer, and a fluorine-based lithium salt, wherein a content of the fluorine-based lithium salt is 20 to 45 wt %.

In the composite solid electrolyte according to an exemplary embodiment of the present invention, the zeolite may further include an alkali metal ion.

In the composite solid electrolyte according to an exemplary embodiment of the present invention, an average particle diameter of zeolite particles may be 200 to 1,000 nm, a specific surface area of the zeolite by a BET measurement method may be 100 to 2,000 m²/g, and an average diameter of zeolite pores may be 1 to 10 nm.

In the composite solid electrolyte according to an exemplary embodiment of the present invention, the zeolite may be Y-type zeolite, and may have a mole ratio between silica (SiO₂) and alumina (Al₂O₃) of 1:1 to 10:1.

In the composite solid electrolyte according to an exemplary embodiment of the present invention, the ion conductive polymer may be a polyalkylene oxide-based polymer.

In the composite solid electrolyte according to an exemplary embodiment of the present invention, the fluorine-based lithium salt may be selected from the group consisting of LiB₄, LiAsF₆, LiPF₆, LiCF₃SO₃, Li(FSO₂)₂N, Li(CF₃SO₂)₃C, LiN(SO₂CF₃)₂, LiN(SO₂CF₂CF₃)₂, LiSbF₆, LiPF₃(CF₂CF₃)₃, LiPF₃ (C₂F₅)₃, LiPF₃ (CF₃)₃, and LiB(C₂O₄)₂, and a content of the fluorine-based lithium salt may be 30 to 40 wt %.

In the composite solid electrolyte according to an exemplary embodiment of the present invention, the composite solid electrolyte may be a freestanding film.

The composite solid electrolyte according to an exemplary embodiment of the present invention may have an elongation of more than 1.5 times or more that of a composite solid electrolyte including 10 wt % of the fluorine-based lithium salt, and may have a work function (WF) of 3.5 eV or more.

In another general aspect, a method for producing a composite solid electrolyte includes: mixing zeolite, an ion conductive polymer, and a fluorine-based lithium salt to produce a mixture; and producing a composite solid electrolyte using the mixture, wherein a content of the fluorine-based lithium salt is 20 to 45 wt %.

In the method for producing a composite solid electrolyte according to an exemplary embodiment of the present invention, the mixture may further include one or more organic solvents selected from the group consisting of acetonitrile, anhydrous N,N-dimethylformamide (DMF), dimethyl sulfoxide (DMSO), propylene carbonate (PC), and ethylene carbonate (EC).

In still another general aspect, a lithium secondary battery includes: a positive electrode; the composite solid electrolyte of claim 1; and a negative electrode.

### Advantageous Effects

The composite solid electrolyte according to the present invention may implement a composite solid electrolyte which may significantly decrease lithium dendrite formation and show very good electrochemical properties even during long-term charge and discharge by optimizing a fluorine-based lithium salt concentration in the composite solid electrolyte to which zeolite is added, and a lithium secondary battery including the same.

### DESCRIPTION OF DRAWINGS

FIG. 1 is a schematic diagram showing a method for producing composite solid electrolyte of the present invention.

FIG. 2 is an image in which YNa zeolite was observed by SEM.

FIG. 3 is a graph showing N₂ adsorption/desorption isotherms of the YNa zeolite.

FIG. 4 is a graph showing a BJH pore size distribution of the YNa zeolite.

FIG. 5 is graphs showing XRD spectra of materials having different PEO, YNa zeolite/PEO, and LiTFSI contents.

FIG. 6 is a graph showing a Raman spectrum of YNa-CPE.

FIGS. 7 and 8 are graphs showing a work function (WF) energy level and lithium dendrite formation of YNa-CPE.

FIG. 9 is graphs showing F1s XPS spectra of YNa-CPE-10 and YNa-CPE-35.

FIG. 10 is graphs showing C1s XPS spectra of YNa-CPE-10 and YNa-CPE-35.

FIG. 11 is images in which a Li metal and YNa-CPE after operation of a [Li|YNa-CPE|Li] cell were observed by SEM.

FIG. 12 is a graph showing a Linear sweep voltammogram of YNa-CPE using a [SS|YNa-CPE|Li] cell.

FIG. 13 is a graph showing cyclic performance of YNa-CPE-35 using the [Li|YNa-CPE|Li] cell.

FIG. 14 is a graph showing cyclic performance of YNa-CPE for contents of various lithium salts using the [Li|YNa-CPE|Li].

FIG. 15 is a graph showing electrical capacity (F/g) of YNa-CPE to a lithium content.

FIG. 16 is a graph showing rate characteristics of YNa-CPE using a [Li|YNa-CPE|LFP] cell.

FIG. 17 is a graph showing cycling performance of YNa-CPE and coulombic efficiency of the [Li|YNa-CPE|LFP] cell.

### BEST MODE

Hereinafter, the composite solid electrolyte of the present invention will be described in detail with reference to the accompanying drawings.

The drawings to be provided below are provided by way of example so that the spirit of the present invention can be sufficiently transferred to a person skilled in the art to which the present invention pertains. Therefore, the present invention is not limited to the drawings provided below but may be embodied in many different forms, and the drawings suggested below may be exaggerated in order to clarify the spirit of the present invention.

Technical terms and scientific terms used herein have the general meaning understood by those skilled in the art to which the present invention pertains, unless otherwise defined, and the description for the known function and configuration which may unnecessarily obscure the gist of the present invention will be omitted in the following description and the accompanying drawings.

In addition, the singular form used in the specification and claims appended thereto may be intended to include a plural form also, unless otherwise indicated in the context.

In the present specification and the appended claims, the terms such as “first” and “second” are not used in a limited meaning but are used for the purpose of distinguishing one constituent element from other constituent elements.

In the present specification and the appended claims, the terms such “comprise” or “have” mean that there is a characteristic or a constituent element described in the specification, and as long as it is not particularly limited, a possibility of adding one or more other characteristics or constituent elements is not excluded in advance.

In the present specification and the appended claims, when a portion such as a membrane (layer), a region, and a constituent element is present on another portion, not only a case in which the portion is in contact with and directly on another portion but also a case in which other membranes (layers), other regions, other constitutional elements, and the like are interposed between the portions is included.

A composite solid electrolyte of the present invention includes: zeolite, an ion conductive polymer, and a fluorine-based lithium salt, wherein a content of the fluorine-based lithium salt is 20 to 45 wt %.

In a specific example, the zeolite may have a structure including an Al, Si, or O element, but may further include an alkali metal ion, preferably further include a sodium ion. By further including the ion, the zeolite may have high thermal stability.

In a specific example, an average particle diameter of zeolite particles may be 200 to 1,000 nm, preferably 300 to 900 nm, and most preferably 400 to 800 nm, but is not limited thereto.

In a specific example, the zeolite particles may have a mesoporous structure, in which the average particle diameter of pores may be 1 to 10 nm, preferably 2 to 9 nm, and most preferably 3 to 8 nm. In addition, a specific surface area of the zeolite by a BET measurement method may be 100 to 2,000 m²/g, preferably 200 to 1,800 m²/g, and most preferably 300 to 1,500 m²/g. An appropriate number of routes for zeolite to transport a lithium ion may be provided by the zeolite particles having the structure, and the diameter and the surface area in the above ranges.

In a specific example, the zeolite may be Y-zeolite. The Y-type zeolite is large pore zeolite in which a pore opening is formed of a ring of 12 oxygen atoms and may have a FAU structure, and specifically, the Y-type zeolite refers to zeolite having a Si/Al ratio of 1.5 or more. Since the Y-type zeolite is a large pore zeolite, relatively large molecules may diffuse into pores, a reactant may easily approach the acid site or metal position of zeolite, and the product may rapidly move out of pores to cause fewer side reactions.

In a specific example, the zeolite may have a mole ratio between silica (SiO₂) and alumina (Al₂O₃) of 1:1 to 10:1, preferably 2:1 to 9:1, and most preferably 3:1 to 8:1, but is not limited thereto.

In a specific example, the ion conductive polymer may be a polyalkylene oxide-based polymer, and as a non-limiting example, may be selected from the group consisting of polyethylene oxide, polypropylene oxide, polybutylene oxide, a polyethylene oxide-polypropylene oxide blend, a polyethylene oxide-polybutylene oxide blend, a polyethylene oxide-polypropylene oxide-polybutylene oxide blend, a polyethylene oxide-polypropylene oxide block polymer, a polyethylene oxide-polybutylene oxide block polymer, a polyethylene oxide-polypropylene oxide-polybutylene oxide block polymer, a polybutylene oxide-polyethylene oxide-polybutylene oxide block polymer, a polyethylene-oxide-polybutylene oxide-polyethylene oxide block polymer, polyethylene oxide grafted polymethylmethacrylate (PEO grafted PMMA), polypropylene oxide grated polymethylmethacrylate (PPO grafted PMMA), and polybutylene oxide grafted polymethylmethacrylate (PBO grafted PMMA), and preferably may be polyethylene oxide. By using the ion conductive polymer, high ion conductivity may be provided, and also a composite solid electrolyte having high stability may be provided.

In a specific example, the ion conductive polymer may have a weight average molecular weight (Mw) of 100,000 to 5,000,000, 500,000 to 2,500,000, or 700,000 to 1,500,000. The ion conductive polymer having an appropriate weight average molecular weight within the range has excellent ion conductivity at room temperature.

In a specific example, the fluorine-based lithium salt may be selected from the group consisting of LiB₄, LiAsF₆, LiPF₆, LiCF₃SO₃, Li(FSO₂)₂N, LiN(SO₂CF₃)₂, Li(CF₃SO₂)₃C, LiN(SO₂CF₂CF₃)₂, LiSbF₆, LiPF₃ (CF₂CF₃)₃, LiPF₃ (C₂F₅)₃, LiPF₃ (CF₃)₃, and LiB(C₂O₄)₂, and may be preferably Li(FSO₂)₂N (lithium bis(fluorosulfonyl)imide; LiFSI) or LiN(SO₂CF₃)₂ (lithium bis(trifluorosulfonyl)imide; LiTFSI). By using the fluorine-based lithium salt, a melting point of a polyethylene oxide-based polymer which is an ion conductive polymer may be lowered, and high flexibility, and excellent thermal, chemical, and electrochemical stability of SO₂CF₃ and —SO₂—N—SO₂— bond which are strong electron-withdrawing groups may be secured.

A content of the fluorine-based lithium salt may be 20 to 45 wt %, preferably 25 to 40 wt %, and most preferably 30 to 40 wt %. The composite solid electrolyte including the fluorine-based lithium salt in the above range has high ion conductivity and also suppresses production of a lithium dendrite, thereby providing a composite solid electrolyte having high stability.

In a preferred specific example, the composite solid electrolyte of the present invention includes Y-zeolite and the fluorine-based lithium salt, preferably LiFSI or LiTFSI together. Since the Y-zeolite may provide a high surface area, and simultaneously adsorb a large amount of a LiFSI or LiTFSI salt, and provide many channels for transporting a lithium ion, ion conductivity may be improved. In addition, since the LiFSI or LiTFSI salt adsorbed on the Y-zeolite provides improved ion conductivity, the lithium ion is completely consumed on the interface between a lithium metal and an electrolyte to suppress lithium dendrite formation.

In a specific example, the solid electrolyte is a film form, and may have a thickness of 10 μm to 300 μm, 30 μm to 250 μm, 70 μm to 230 μm, 100 μm to 200 μm, or 150 μm to 200 μm. Since the solid electrolyte has an appropriate thickness, it contains sufficient amounts of an ion conductive polymer and a lithium salt to show excellent ion conductivity.

In a specific example, the composite solid electrolyte may be a freestanding film. A freestanding film refers to a film having a portion which is not attached to a support such as a wall or a substrate, like a microporous structure. The composite solid electrolyte of the present invention may be used by itself, not by a method of coating other materials, and is easily produced and handled.

In a specific example, since the composite solid electrolyte includes the fluorine-based lithium salt, elongation is improved. It has higher elongation than a composite solid electrolyte including no fluorine-based lithium salt, and specifically twice or more or three times or more, and unlimitedly 20 times or less of elongation. For example, as compared with a composite solid electrolyte including 10 wt % of the fluorine-based lithium salt, the composite solid electrolyte may have an elongation of 1.5 times or more, preferably 2 times or more, and unlimitedly 10 times or less. When it corresponds to the elongation in the above range, a ratio of a crystalline portion is lowered and better elasticity and elongation are shown, and thus, lithium dendrite formation may be suppressed.

In a specific example, the composite solid electrolyte may have a work function (WF) of 3.5 eV or more, preferably 3.6 eV or more, and most preferably 3.7 eV or more. Since an outer surface of a lithium metal generally has a higher work function, it shows higher resistance than an electrolyte having a lower work function and forms a dendrite on the surface of the lithium metal, and when it has the work function in the above range, a σ value is improved by the improved work function, and interfacial contact resistance with a Li metal is decreased. In addition, as the work function of the composite solid electrolyte is increased, consumption of the lithium ion on an outer surface of the lithium metal is improved to slow down dendrite formation.

A method for producing a composite solid electrolyte of the present invention includes: mixing zeolite, an ion conductive polymer, and a fluorine-based lithium salt to produce a mixture; and producing a composite solid electrolyte using the mixture, wherein a content of the fluorine-based lithium salt is 20 to 45 wt %.

In a specific example, the mixture may further include one or more organic solvents selected from the group consisting of acetonitrile, anhydrous N,N-dimethylformamide (DMF), dimethyl sulfoxide (DMSO), propylene carbonate (PC), and ethylene carbonate (EC).

Herein, the mixture may be produced by mixing each material in a temperature range of 40° C. to 80° C. for 1 hour to 96 hours. The mixing may be performed by stirring. For example, the mixing may be performed in a temperature range of 50° C. to 70° C. or 60° C. to 70° C. for 6 hours to 48 hours or 12 hours to 36 hours.

A lithium secondary battery of the present invention is characterized by including: a positive electrode; the composite solid electrolyte of claim 1; and a negative electrode.

In the lithium secondary battery, the positive electrode is formed on a current collector, and may include a lithium transition metal oxide as an active material. A reticulated or mesh shaped porous body may be used as the current collector, and a porous metal plate such as nickel or aluminum may be used. In addition, a lithium-containing transition metal oxide may be used as the active material, and more specifically, any one or a mixture of two or more selected from the group consisting of LiCoO₂, LiNiO₂, LiMnO₂, LiMn₂O₄, LiCoPO₄, and LiFePO₄ may be used. In addition, sulfide, selenide, halide, and the like may be used in addition to the oxide. In addition, a positive electrode active material in a Li-free form is initially possible, and for example, may be TiS₂, FeS₂, V₂O₅, or the like.

In the lithium secondary battery, the negative electrode may include a lithium metal as an active material which may adsorb and release lithium. Since the lithium metal has low density and low standard reduction potential, it is useful as a negative electrode of a lithium secondary battery having high energy density and excellent discharge capacity maintenance properties.

In the lithium secondary battery, a solid electrolyte may be interposed between the positive electrode and the negative electrode. The solid electrolyte may act as an electrolyte and a separator in the lithium secondary battery.

### BEST MODE FOR CARRYING OUT THE INVENTION

Hereinafter, the present invention will be described in detail by the examples. However, the examples are for describing the present invention in more detail, and the scope of the present invention is not limited to the following examples.

### <Example 1> Production of YNa-CPE-35

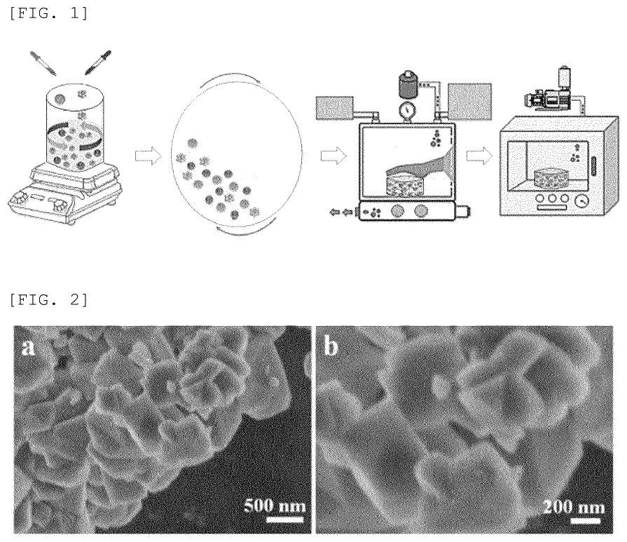

In order to produce a composite solid electrolyte, 0.14 g of LiN(SO₂CF₃)₂ (lithium bis(trifluorosulfonyl)imide; LiTFSI) and 0.0251 g of Y-type zeolite containing Na (Zeolite Y sodium; ZYNa) were dispersed in an acetonitrile (ACN) solvent at a speed of 800 rpm for 24 hours by magnetic stirring to obtain a mixture of LiTFSI and ZYNa. Next, 0.4 g of polyethylene oxide (PEO) was added to the mixed solution and stirring was further performed for 24 hours. 15 ml of ACN was added to the mixed solution, and then ball milling (ball size=10 nm) was performed at a speed of 100 rpm for 48 hours. Next, the mixed solution was poured into a Teflon petri dish, and then dried in a glove box at room temperature for 48 hours. Finally, the sample was dried under vacuum at 60° C. for 24 hours to obtain a YNa composite solid electrolyte film. The composite solid electrolyte film having a lithium salt content of 35 wt % was expressed as YNa-CPE-35. The method for producing YNa-CPE is shown in FIG. 1.

### <Example 2> Production of YNa-CPE-32

A composite solid electrolyte film was produced in the same manner as in Example 1, except that 0.128 g of LiTFSI was used instead of 0.14 g of LiTFSI. The composite solid electrolyte film having a lithium salt content of 32 wt % was expressed as YNa-CPE-32.

### <Example 3> Production of YNa-CPE-38

A composite solid electrolyte film was produced in the same manner as in Example 1, except that 0.152 g of LiTFSI was used instead of 0.14 g of LiTFSI. The composite solid electrolyte film having a lithium salt content of 38 wt % was expressed as YNa-CPE-38.

### <Comparative Example 1> Production of YNa-CPE-10

A composite solid electrolyte film was produced in the same manner as in Example 1, except that 0.04 g of LiTFSI was used instead of 0.14 g of LiTFSI. The composite solid electrolyte film having a lithium salt content of 10 wt % was expressed as YNa-CPE-10.

### <Comparative Example 2> Production of YNa-CPE-20

A composite solid electrolyte film was produced in the same manner as in Example 1, except that 0.08 g of LiTFSI was used instead of 0.14 g of LiTFSI. The composite solid electrolyte film having a lithium salt content of 20 wt % was expressed as YNa-CPE-20.

### <Comparative Example 3> Production of YNa-CPE-30

A composite solid electrolyte film was produced in the same manner as in Example 1, except that 0.12 g of LiTFSI was used instead of 0.14 g of LiTFSI. The composite solid electrolyte film having a lithium salt content of 30 wt % was expressed as YNa-CPE-30.

### <Comparative Example 4> Production of YNa-CPE-40

A composite solid electrolyte film was produced in the same manner as in Example 1, except that 0.16 g of LiTFSI was used instead of 0.14 g of LiTFSI. The composite solid electrolyte film having a lithium salt content of 40 wt % was expressed as YNa-CPE-40.

### <Experimental Example 1> Analysis of Structure of YNa Zeolite

First, the structure of ZYNa which is a basic material of the composite solid electrolyte of the present invention was observed by SEM.

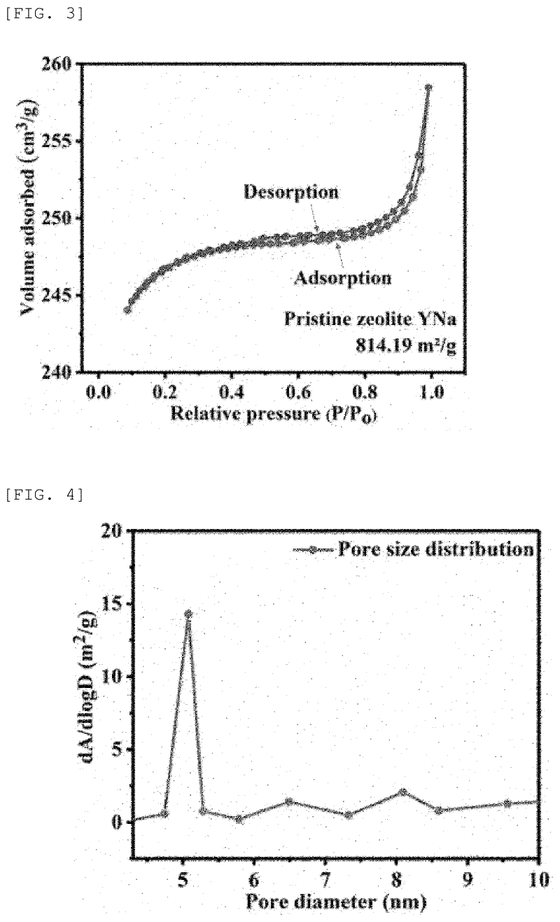

Referring to FIG. 2, ZYNa particles showed a largely uniform size of about 200 to 1,000 nm, and did not show the characteristics of agglomerating together.

Next, the presence or absence of pores and the pore size on the surface of ZYNa were observed. N₂ adsorption/desorption was performed for surface analysis (Tristar-3000, micromeritics) of ZYNa, and the surface area and the pore size distribution were measured by Brunauer-Emmett-Teller (BET) and Barrett-Joyner-Halenda (BJH) methods, respectively.

Referring to FIG. 3, since the adsorption/desorption isothermal graph of type IV was able to be confirmed through a N₂ adsorption/desorption isotherm, it was shown that ZYNa had a mesopore structure.

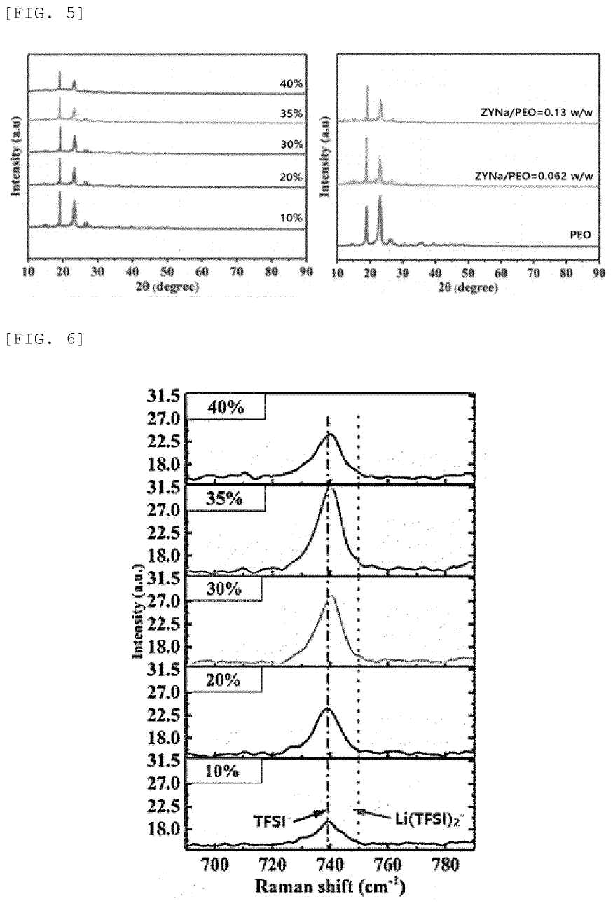

In addition, referring to FIG. 4, it was shown that ZYNa had an average pore diameter of ˜5 nm through a pore size distribution, and as a result of calculation by a Brunauer-Emmett-Teller (BET) method, it was confirmed that ZYNa had a high specific surface area value of 814.19 m²/g. ZYNa having a large surface area as such may form an interface having excellent conductivity between ZYNa and PEO, and may contribute to dissociation of the LiTFSI salt.

### <Experimental Example 2> Analysis of Structure of YNa-CPE Film

In order to observe a crystal phase of a composite electrolyte having a lithium salt content in a range of 10 wt % to 40 wt %, X-ray diffraction (XRD, Empyrean-Malvern Panalytical) was measured from 10° to 90° using a CuKα radiation.

Referring to FIG. 5, it was shown that the crystallinity of PEO was not decreased by addition of ZYNa. This means that action between PEO and ZYNa is weaker than action between PEO and LiTFSI. In addition, the PEO film showed a stronger peak intensity than the YNa-CPE film at 19.07° and 23.1°, and this means that LiTFSI was uniformly distributed in PEO and the amorphous properties of PEO were improved to promote the movement of lithium ions. However, a peak related to LiTFSI was not observed, and this means that the LiTFSI salt was completely dissolved in all YNa-CPE samples. The intensity of the peak corresponding to PEO became weak as a larger amount of the lithium salt was added, and when 40 wt % of the lithium salt was added, more amorphous areas were shown in PEO, thereby improving the conductivity of the lithium ion.

In order to observe the concentration of the ion included in a composite electrolyte having a lithium salt content in a range of 10 wt % to 40 wt %, RAMAN measurement was performed. A Thermo Scientific/Nicolet Almega XR spectroscope equipped with 532 nm laser in a range of 75-1287 cm⁻¹ was used to obtain a RAMAN spectrum (laser output=80%, resolution=1.1-1.3 cm⁻¹).

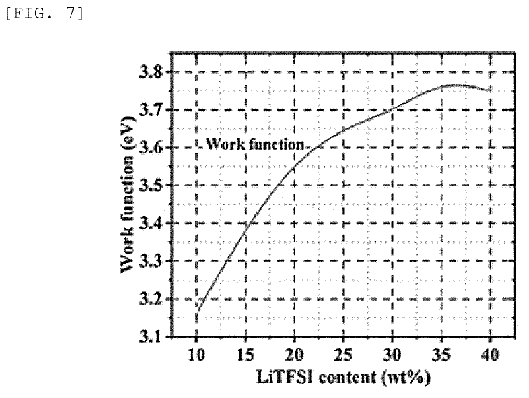

Referring to FIG. 6, a peak corresponding to TFSI was observed at 738 cm⁻¹, but a peak corresponding to Li(TFSI)₂ was not observed except for YNa-CPE-40. The concentration of TFSI should be high for excellent conductivity, and the increased concentration of Li(TFSI)₂ means that a cluster which was a factor in lowering a numerical value of σ was formed. As the content of the added lithium salt increased to 35 wt %, the concentration of TFSI increased, but as the content of the lithium salt further increased, the concentration of TFSI began to decrease. That is, the largest σ was shown in YNa-CPE-35 and the smallest σ value was shown in YNa-CPE-40, and this may be due to formation of the cluster.

In order to observe a formation degree of a dendrite according to the work function of the composite electrolyte having a lithium salt content in a range of 10 wt % to 40 wt %, the work function of the YNa-CPE film was measured using ultraviolet photoelectron spectroscopy (UPS, M/s Thermo Scientific, ESCALAB 250Xi).

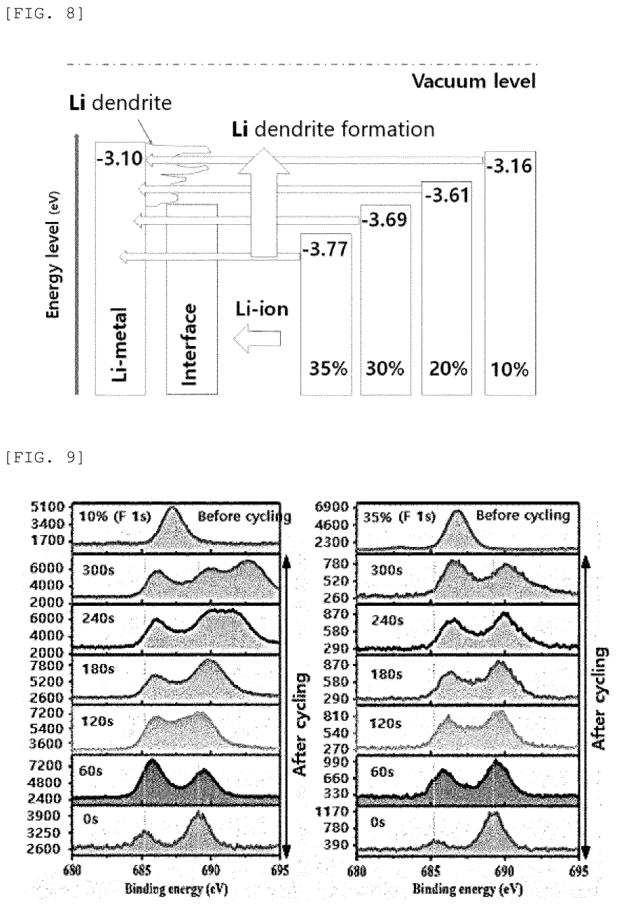

Referring to FIG. 7, the work function (WF) of YNa-CPE increased as the content of the lithium salt increased. The maximum value of WF (3.77 eV) was shown in 35 wt %, and it was shown therefrom that YNa-CPE-35 had an excellent contact with the lithium metal. Additionally, referring to FIG. 8, the principle of lithium dendrite formation according to the work function is shown, and since the outer surface of the lithium metal generally has a higher work function, high resistance is shown to an electrolyte having a low work function, so that a dendrite is formed on the surface of the lithium metal, and a σ value is improved due to the improved work function and interfacial contact resistance with the lithium metal is decreased to decrease dendrite formation.

Next, in order to measure interfacial degradation between YNa-CPE and the lithium metal, X-ray photoelectron spectroscopy (XPS, M/s Thermo Scientific, ESCALAB 250Xi) measurement on YNa-CPE was performed to analyze the elemental composition of the sample. A monochromatic Alkα X-ray source (1486.6 eV) was mounted on XPS.

Referring to FIG. 9, before cycling, there was only one peak corresponding to LiTFSI in YNa-CPE-10 and YNa-CPE-35, but after cycling, two peaks were observed at 685.20 and 689.08 eV, which corresponded to LiF and CF₃, respectively. However, in YNa-CPE-10, an additional peak was shown at 687.1 eV after etching for 120 seconds, which was a peak corresponding to Li—O—F. Thus, it was confirmed that YNa-CPE-10 was decomposed after cycling, and the decomposition phenomenon in YNa-CPE-35 occurred much less.

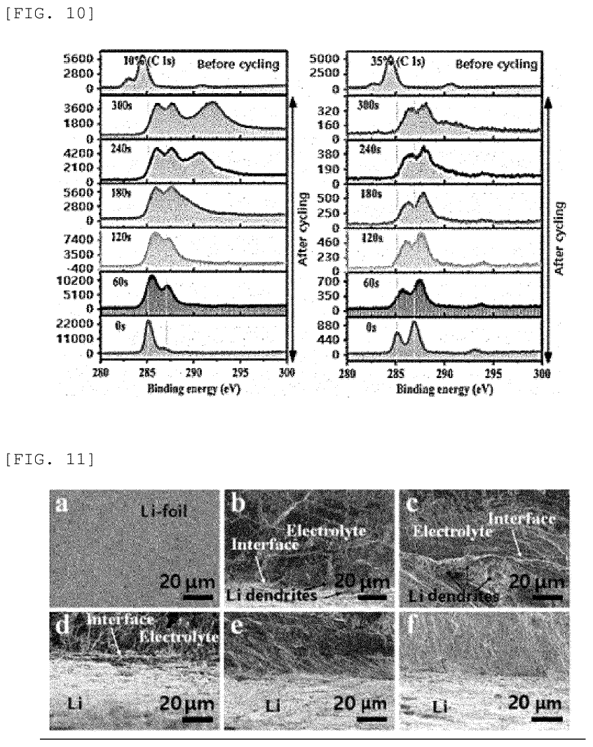

Referring to FIG. 10, in YNa-CPE-10, a peak intensity increased at 287.02 eV corresponding to a C—O bond as an etching time increased, and after etching for 240 seconds, an addition peak was observed at 290.8 eV, which corresponded to a C═O bond. However, in YNa-CPE-35, an additional peak corresponding to a C═O bond was not observed. It was confirmed therefrom that when 35 wt % of the lithium salt was included, the decomposition phenomenon occurred less than in YNa-CPE-10.

Next, in order to confirm whether a dendrite was formed in a composite electrolyte having a lithium salt content in a range of 10 wt % to 40 wt %, observation was performed by SEM in the interface between YNa-CPE and a Li metal.

Referring to FIG. 11, a front view of an SEM image of a lithium foil is shown in (a) of FIG. 11, and cross-sectional images of a [Li|YNa-CPE|Li] cell are shown in (b) to (f) of FIG. 11. In YNa-CPE-10 ((b) of FIG. 11) and YNa-CPE-20 ((c) of FIG. 11) cells, dendrites were observed on the surface of the lithium metal. However, no dendrite was observed at a higher lithium salt concentration ((c) to (e) of FIG. 11).

### <Experimental Example 3> Electrochemical Analysis

A YNa-CPE film was disposed between two metal disk (stainless steel, SS) electrodes to form a cell in the form of [SS|YNa-CPE|SS]. Thereafter, EIS measurement was performed in a temperature range of 20 to 70° C. Before each measurement, a cell having a [SS|YNa-CPE|SS] structure was thermally stabilized for 4 hours.

In order to investigate electrochemical stability of the composite solid electrolyte for the lithium metal during cell operation at a high voltage, linear sweep voltammetry (LSV) was performed at a speed of 5 mV/s in a range of 3.0 to 6.0 V (vs. Li/Lit) for a [SS|YNa-CPE|Li] cell at 60° C.

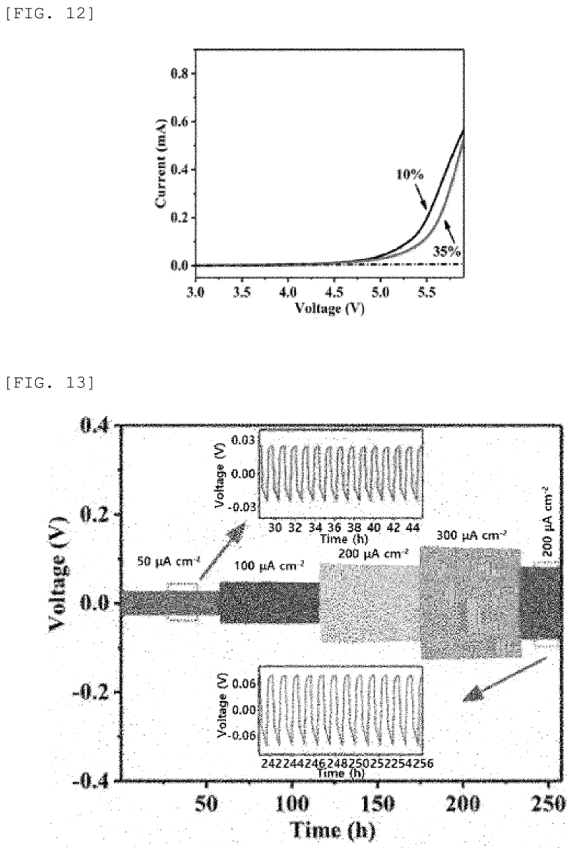

Referring to FIG. 12, it was confirmed that the cell including the YNa-CPE-35 composite solid electrolyte maintained stability to 4.65 V, and the cell including the YNa-CPE-10 composite solid electrolyte started oxidation at 4.55 V. Therefore, it was confirmed that the composite solid electrolyte containing an optimal amount of the lithium salt in YNa-CPE was able to improve electrochemical stability as well as the σ value.

In order to evaluate long-term compatibility and the electrochemical stability of YNa-CPE for a lithium metal, galvanostatic lithium plating and stripping (GLPS) analysis was performed using a [Li|YNa-CPE|Li] battery.

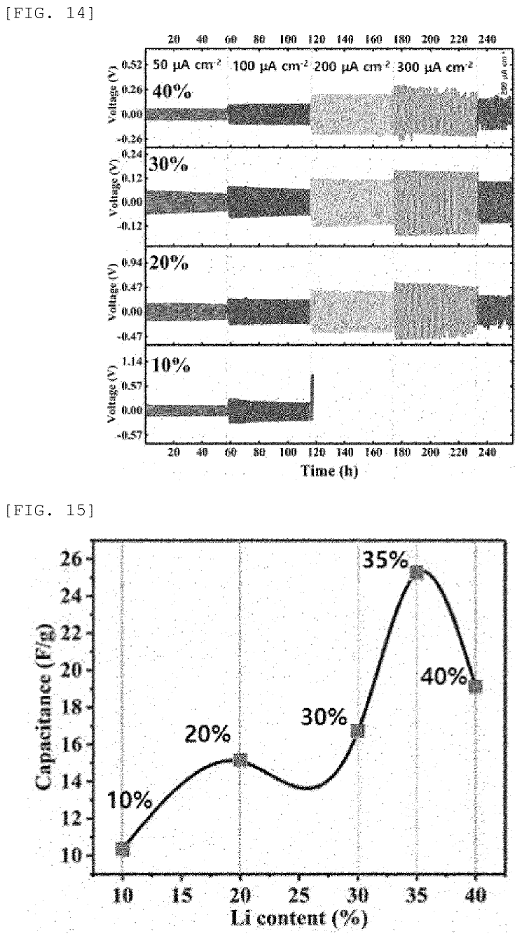

Referring to FIG. 13, a voltage-time profile of YNa-CPE-35 is shown at current densities of 50, 100, 200, and 300 μA/cm @60° C., and referring to FIG. 14, a voltage-time profile of YNa-CPE having lithium salt contents of 10, 20, 30, and 40 wt % is shown. Overpotential was decreased as a lithium salt concentration was increased, and when 35 wt % of the lithium salt was included, the overpotential was the lowest, but was increased as the lithium salt content was further increased.

More specifically, voltages of 0.025, 0.046, 0.088, and 0.12 V were shown in current densities of 50, 100, 200, and 300 μA·cm⁻² for YNa-CPE-35, and considering that the voltages obtained each current density were almost constant, it is shown that YNa-CPE-35 was the most stable even at a high current density. However, YNa-CPE-10 was not stable at a current density of 200 μA·cm⁻², and YNa-CPE-20 and YNa-CPE-40 showed low stability at 300 μA·cm⁻². Thus, it was shown that in YNa-CPE-35, the σ value was improved due to the high WF and overpotential was decreased over time by decreased interfacial contact resistance with a lithium metal, but at a low lithium salt content (10 wt % and 20 wt %), since a lithium dendrite was able to penetrate into a polymer due to weak mechanical strength, stability was decreased.

A change in electrical capacity (Cs) in the composite electrolyte having a lithium salt content in a range of 10 wt % to 40 wt % was observed.

Referring to FIG. 15, a Cs value for YNa-CPE-10 was found to be 10.38 F/g, and as the lithium content increased, the Cs value also increased and a maximum Cs value was 25.22 F/g in YNa-CPE-35. However, as the lithium content further increased, and the Cs value was confirmed to be decreased to 19.10 F/s in YNa-CPE-40.

A discharge capacity ratio (rate capability) of YNa-CPE using an LFP negative electrode was measured.

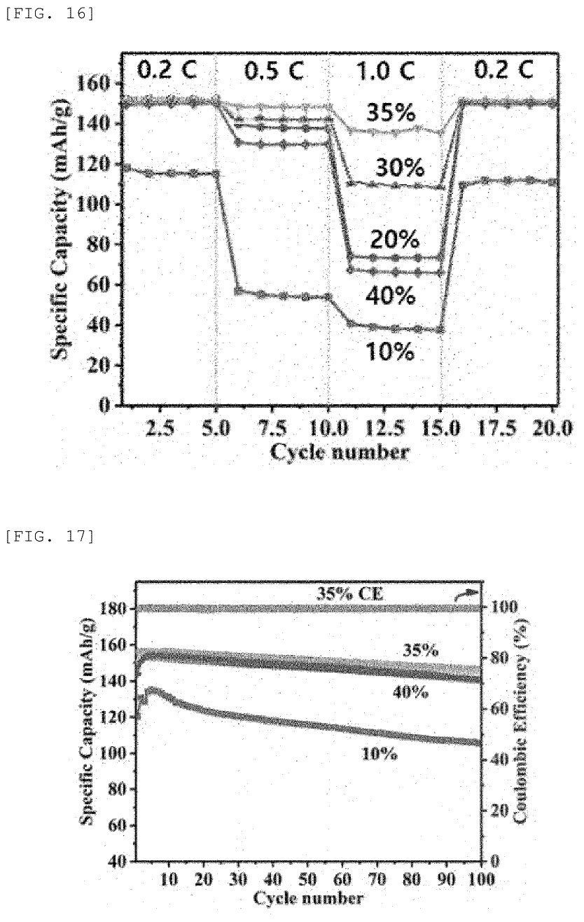

Referring to FIG. 16, in YNa-CPE-10, a specific capacity was 118.20 mAh/g at a C-rate of 0.2 C, and was greatly decreased to 57.14 and 40.35 mAh/g at C-rates of 0.5 C and 1.0 C, respectively. However, as the lithium content increased, the capacity was greatly improved, and the best performance was obtained in YNa-CPE-35. The specific capacity value of YNa-CPE-35 was 152.36 mAh/g at 0.2 C, and 149.34 and 138.00 mAh/g at C-rates of 0.5 C and 1.0 C, respectively, and it was confirmed therefrom that a reduction rate of the specific capacity was decreased.

Cyclic performance and coulombic efficiency of YNa-CPE using an LFP negative electrode were measured.

Referring to FIG. 17, the capacity of YNa-CPE-10 was initially 120.04 mAh/g, was increased to 134.64 mAh/g after 5 cycles, and was gradually decreased as the cycles increased. Finally, the capacity obtained after 100 cycles was 105.96 mAh/g. However, as the lithium salt content increased, the capacity was greatly increased, and the highest capacity was shown in YNa-CPE-35. The capacity was initially 156.63 mAh/g and was increased to 156.92 mAh/g after two cycles. The capacity was a little decreased to 149.10 mAh/g after 100 cycles (RR=95.19%). The obtained coulombic efficiency was 99.23% and 99.55% for YNa-CPE-10 and YNa-CPE-35, respectively.

As described above, the composite solid electrolyte according to the present invention may implement a composite solid electrolyte which may significantly decrease lithium dendrite formation and show very good electrochemical properties even during long-term charge and discharge by optimizing a fluorine-based lithium salt concentration in the composite solid electrolyte to which zeolite is added.

1. A composite solid electrolyte comprising: zeolite, an ion conductive polymer, and a fluorine-based lithium salt,
wherein a content of the fluorine-based lithium salt is 20 to 45 wt %.

2. The composite solid electrolyte of claim 1, wherein the zeolite further includes an alkali metal ion.

3. The composite solid electrolyte of claim 1, wherein zeolite particles have an average particle diameter of 200 to 1,000 nm.

4. The composite solid electrolyte of claim 1, wherein the zeolite has a specific surface area by a BET measurement method of 100 to 2,000 m²/g.

5. The composite solid electrolyte of claim 1, wherein zeolite pores have an average diameter of 1 to 10 nm.

6. The composite solid electrolyte of claim 1, wherein the zeolite is Y-type zeolite.

7. The composite solid electrolyte of claim 1, wherein the zeolite has a mole ratio between silica (SiO₂) and alumina (Al₂O₃) of 1:1 to 10:1.

8. The composite solid electrolyte of claim 1, wherein the ion conductive polymer is a polyalkylene oxide-based polymer.

9. The composite solid electrolyte of claim 1, wherein the fluorine-based lithium salt is selected from the group consisting of LiB₄, LiAsF₆, LiPF₆, LiCF₃SO₃, Li(FSO₂)₂N, Li(CF₃SO₂)₃C, LiN(SO₂CF₃)₂, LiN(SO₂CF₂CF₃)₂, LiSbF₆, LiPF₃ (CF₂CF₃)₃, LiPF₃ (C₂F₅)₃, LiPF₃ (CF₃)₃, and LiB(C₂O₄)₂.

10. The composite solid electrolyte of claim 9, wherein the fluorine-based lithium salt is Li(FSO₂)₂N or LiN(SO₂CF₃)₂.

11. The composite solid electrolyte of claim 1, wherein a content of the fluorine-based lithium salt is 30 to 40 wt %.

12. The composite solid electrolyte of claim 1, wherein the composite solid electrolyte is a freestanding film.

13. The composite solid electrolyte of claim 1, wherein the composite solid electrolyte has an elongation of 1.5 times or more that of a composite solid electrolyte including 10 wt % of the fluorine-based lithium salt.

14. The composite solid electrolyte of claim 1, wherein the composite solid electrolyte has a work function of 3.5 eV or more.

15. A method for producing a composite solid electrolyte, the method comprising:
mixing zeolite, an ion conductive polymer, and a fluorine-based lithium salt to produce a mixture; and
producing a composite solid electrolyte using the mixture,
wherein a content of the fluorine-based lithium salt is 20 to 45 wt %.

16. The method for producing a composite solid electrolyte of claim 15, wherein the mixture further includes one or more organic solvents selected from the group consisting of acetonitrile, anhydrous N,N-dimethylformamide (DMF), dimethyl sulfoxide (DMSO), propylene carbonate (PC), and ethylene carbonate (EC).

17. A lithium secondary battery comprising: a positive electrode; the composite solid electrolyte of claim 1; and a negative electrode.
